(19) United States
(12) Patent Application Publication
(10) Pub. No.: US 2023/0379714 A1
(43) Pub. Date: Nov. 23, 2023

(54) APPARATUS AND METHOD FOR 5G SECURITY MANAGEMENT OF MALICIOUS DEVICE BASED ON OPEN-RADIO ACCESS NETWORK ARCHITECTURE

(71) Applicant: National Yang Ming Chiao Tung University, Hsinchu City (TW)

(72) Inventors: Encheng LIOU, Hsinchu City (TW); Bao-Shuh Paul LIN, Hsinchu City (TW); Chung-Hsiang CHENG, New Taipei City (TW); Tzu Hang LIN, Hsinchu County (TW); Yu-Chee TSENG, Hsinchu City (TW)

(21) Appl. No.: 18/054,920

(22) Filed: Nov. 14, 2022

(30) Foreign Application Priority Data
May 19, 2022 (TW) 111118770

(51) Int. Cl. H04W 12/121

(52) U.S. Cl. CPC H04W 12/121

(57) ABSTRACT

An apparatus for 5G security management of a malicious device based on an open-radio access network (O-RAN) architecture includes a service management orchestration (SMO) unit, an O-RAN element unit and an artificial intelligence (AI) processing unit. The SMO unit includes a non-real time radio access network intelligent controller (non-RT RIC). The non-RT RIC collects a non-real time traffic data of a user. The O-RAN element unit includes a near-real time radio access network intelligent controller (near-RT RIC). The near-RT RIC collects a near-real time traffic data of the user. The AI processing unit is configuring to classify the user into one of a plurality of categories, predict at least one traffic index of the user, and determine whether the user is the malicious device.

### RELATED APPLICATIONS

This application claims priority to Taiwan Application Serial Number 111118770, filed May 19, 2022, which is herein incorporated by reference.

### BACKGROUND

### Technical Field

The present disclosure relates to an apparatus and a method for security management of a malicious device. More particularly, the present disclosure relates to an apparatus and a method for 5G security management of a malicious device based on an open-radio access network architecture.

### Description of Related Art

The conventional security management device of a mobile data and the conventional information security testing tools usually perform a security protecting process via a hardware equipment, and develop on the data plane. However, the open-radio access network (O-RAN) architecture of 5G network separates the control plane of the router from the data plane, and is implemented in software. Therefore, the control planes distributed in different network devices can be managed concentratively without changing the hardware equipment, and can be programed by a central control program.

Thus, the conventional security management device cannot be applied to the characteristic of the 5G control plane and the O-RAN architecture, and cannot combine the control signal with a signal of the underlying equipment.

Thus, developing an apparatus and a method for 5G security management of a malicious device based on the O-RAN architecture which is applied to the 5G O-RAN architecture, combing the user behavior of the control plane and the data plane, and immediately distinguishing the malicious device in the field are commercially desirable.

### SUMMARY

According to one aspect of the present disclosure, an apparatus for 5G security management of a malicious device based on an open-radio access network (O-RAN) architecture includes a service management orchestration (SMO) unit, an O-RAN element unit and an artificial intelligence (AI) processing unit. The SMO unit includes a non-real time radio access network intelligent controller (non-RT RIC). The non-RT RIC collects a non-real time traffic data of a user. The O-RAN element unit is signally connected to the SMO unit, and includes a near-real time radio access network intelligent controller (near-RT RIC). The near-RT RIC collects a near-real time traffic data of the user. The AI processing unit is signally connected to the non-RT RIC and the near-RT RIC, receives at least one of the non-real time traffic data and the near-real time traffic data, and configured to implement a method for 5G security management of the malicious device based on the O-RAN architecture. The method for 5G security management of the malicious device based on the O-RAN architecture includes performing a classifying step, an index predicting step and a determining step. The classifying step is performed to classify the user into one of a plurality of categories according to the at least one of the non-real time traffic data and the near-real time traffic data. The index predicting step is performed to calculate the one of the categories and the at least one of the non-real time traffic data and the near-real time traffic data by an AI model to predict at least one traffic index of the user. The determining step is performed to determine whether the user is the malicious device according to the at least one traffic index of the user.

According to another aspect of the present disclosure, an apparatus for 5G security management of a malicious device based on an open-radio access network (O-RAN) architecture includes a service management orchestration (SMO) unit and an O-RAN element unit. The SMO unit includes a non-real time radio access network intelligent controller (non-RT RIC). The non-RT RIC collects a non-real time traffic data of a user, and includes at least one artificial intelligence (AI) processing unit. The O-RAN element unit is signally connected to the SMO unit, and includes a near-real time radio access network intelligent controller (near-RT RIC). The near-RT RIC collects a near-real time traffic data of the user. The AI processing unit is signally connected to the near-RT RIC, receives at least one of the non-real time traffic data and the near-real time traffic data, and configured to implement a method for 5G security management of the malicious device based on the O-RAN architecture. The method for 5G security management of the malicious device based on the O-RAN architecture includes performing a classifying step, an index predicting step and a determining step. The classifying step is performed to classify the user into one of a plurality of categories according to the at least one of the non-real time traffic data and the near-real time traffic data. The index predicting step is performed to calculate the one of the categories and the at least one of the non-real time traffic data and the near-real time traffic data by an AI model to predict at least one traffic index of the user. The determining step is performed to determine whether the user is the malicious device according to the at least one traffic index of the user.

According to further another aspect of the present disclosure, a method for 5G security management of a malicious device based on an open-radio access network (O-RAN) architecture includes performing a first data collecting step, a second data collecting step, a classifying step, an index predicting step and a determining step. The first data collecting step is performed to configure a non-real time radio access network intelligent controller (non-RT RIC) of a service management orchestration (SMO) unit to collect a non-real time traffic data of a user, and transmit the non-real time traffic data to an artificial intelligence (AI) processing unit. The second data collecting step is performed to configure a near-real time radio access network intelligent controller (near-RT RIC) of an O-RAN element unit to collect a near-real time traffic data of the user, and transmit the near-real time traffic data to the AI processing unit. The classifying step is performed to configure the AI processing unit to classify the user into one of a plurality of categories according to at least one of the non-real time traffic data and the near-real time traffic data. The index predicting step is performed to configure the AI processing unit to calculate the one of the categories and the at least one of the non-real time traffic data and the near-real time traffic data by an AI model to predict at least one traffic index of the user.

The determining step is performed to configure the AI processing unit to determine whether the user is the malicious device according to the at least one traffic index of the user. The O-RAN element unit is signally connected to the SMO unit, and the AI processing unit is signally connected to the near-RT RIC.

### BRIEF DESCRIPTION OF THE DRAWINGS

The present disclosure can be more fully understood by reading the following detailed description of the embodiment, with reference made to the accompanying drawings as follows:

FIG. 1 shows a block diagram of an apparatus for 5G security management of a malicious device based on an open-radio access network architecture according to a first embodiment of the present disclosure.

FIG. 2 shows a schematic view of an open-radio access network architecture.

FIG. 3 shows a flow chart of a method for 5G security management of a malicious device based on an open-radio access network architecture according to a second embodiment of the present disclosure.

FIG. 4 shows a flow chart of a method for 5G security management of a malicious device based on an open-radio access network architecture according to a third embodiment of the present disclosure.

FIG. 5 shows a block diagram of an apparatus for 5G security management of a malicious device based on an open-radio access network architecture according to a fourth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

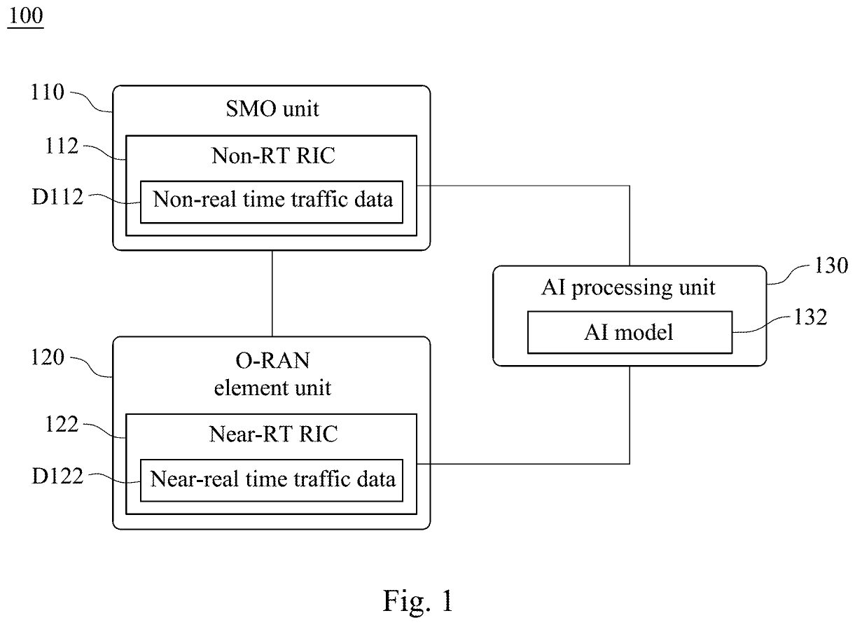

Please refer to FIG. 1. FIG. 1 shows a block diagram of an apparatus 100 for 5G security management of a malicious device based on an open-radio access network (O-RAN) architecture according to a first embodiment of the present disclosure. The apparatus 100 for 5G security management of the malicious device based on the O-RAN architecture includes a service management orchestration (SMO) unit 110, an O-RAN element unit 120 and an artificial intelligence (AI) processing unit 130. The SMO unit 110 includes a non-real time radio access network intelligent controller (non-RT RIC) 112. The non-RT RIC 112 collects a non-real time traffic data D112 of a user (client). The O-RAN element unit 120 is signally connected to the SMO unit 110, and includes a near-real time radio access network intelligent controller (near-RT RIC) 122. The near-RT RIC 122 collects a near-real time traffic data D122 of the user. The AI processing unit 130 is signally connected to the non-RT RIC 112 and the near-RT RIC 122, receives at least one of the non-real time traffic data D112 and the near-real time traffic data D122, and configures to implement a method for 5G security management of the malicious device based on the O-RAN architecture. The method for 5G security management of the malicious device based on the O-RAN architecture includes performing a classifying step, an index predicting step and a determining step. The classifying step is performed to classify the user into one of a plurality of categories according to the at least one of the non-real time traffic data D112 and the near-real time traffic data D122. The index predicting step is performed to calculate the one of the categories and the at least one of the non-real time traffic data D112 and the near-real time traffic data D122 by an AI model 132 to predict at least one traffic index of the user. The determining step is performed to determine whether the user is the malicious device according to the at least one traffic index of the user.

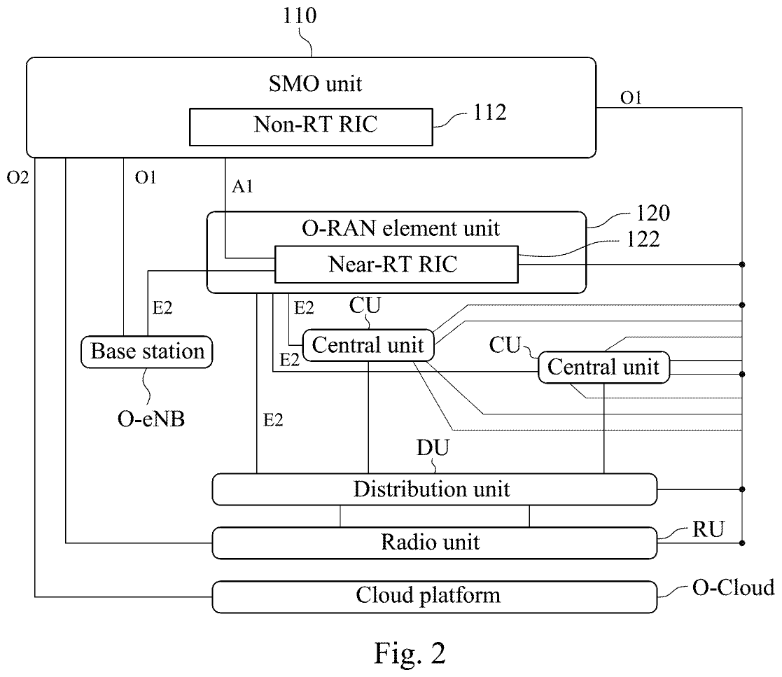

Please refer to FIG. 1 and FIG. 2. FIG. 2 shows a schematic view of an O-RAN architecture. In detail, the O-RAN architecture is shown as FIG. 2. The SMO unit 110 can be a management platform of the O-RAN architecture, and is for the user to monitor the performance and state of all the devices connected to the O-RAN architecture. The operation time of the non-RT RIC 112 is greater than or equal to 1 s (second), and the non-RT RIC 112 is for the non-real time flow monitoring. The non-RT RIC 112 collects the non-real time traffic data D112 via an O1 interface. The O-RAN element unit 120 can be any communicating element which is equipped with a near-RT RIC 122 in the O-RAN architecture. The operation time of the near-RT RIC 122 is greater than or equal to 10 m s, and less than 1 s. The near-RT RIC 122 is for the near-real time flow monitoring. The near-RT RIC 122 collects the near-real time traffic data D122 via an E2 interface. Each of the non-real time traffic data D112 and the near-real time traffic data D122 is at least one of a control plane, a data plane and a time stamp. Moreover, each of the non-real time traffic data D112 and the near-real time traffic data D122 can be a package information, which is collects by a plurality of interfaces (e.g., an O1 interface, an O2 interface, an A1 interface, an E2 interface) of the O-RAN architecture, a control message of a management system or historical information from a database, but the present disclosure is not limited thereto.

In detail, the SMO unit 110 collects the non-real time traffic data D112 from a base station O-eNB, a radio unit RU, a central unit CU and a distribution unit DU via the O1 interface, and is connected to the cloud platform O-cloud via the O2 interface. The O-RAN element unit 120 collects the near-real time traffic data D122 from the base station O-eNB, the central unit CU and the distribution unit DU via the E2 interface, and is connected to the non-RT RIC 112 via the A1 interface. The AI processing unit 130 can be a back end data analyzing processor, but the present disclosure is not limited thereto. In FIG. 2, the undotted lines, which are extended from the central units CU to the right side of FIG. 2, are connected to other external devices.

Further, the SMO unit 110, the O-RAN element unit 120 and the AI processing unit 130 can be different kind of physical electronic processing device, microprocessor, virtual operator or other computing software and electronic processor applied to O-RAN architecture. In other embodiments, a number of the O-RAN element unit can be plural, but the present disclosure is not limited thereto.

Thus, the apparatus 100 for 5G security management of the malicious device based on the O-RAN architecture can be set for the O-RAN architecture by the software, monitor the state of the traffic data and the information security of the protocol of the under layer communicating device (i.e., O-RAN element unit 120) and the protocol of the upper layer management device (i.e., SMO unit 110) constantly, and then train the aforementioned traffic data by the AI model 132 to distinguish the malicious device. The aforementioned classifying step, the index predicting step and the determining step are described in more detail below.

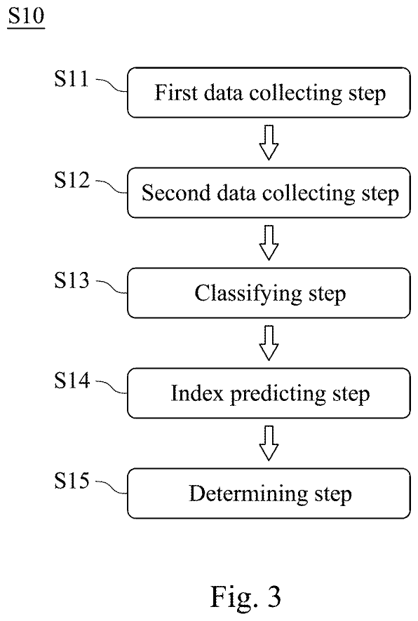

Please refer to FIG. 1 and FIG. 3. FIG. 3 shows a flow chart of a method S10 for 5G security management of a malicious device based on an open-radio access network (O-RAN) architecture according to a second embodiment of the present disclosure. The method S10 for 5G security management of the malicious device based on the O-RAN architecture includes performing a first data collecting step S11, a second data collecting step S12, a classifying step S13, an index predicting step S14 and a determining step S15. The first data collecting step S11 is performed to configure a non-real time radio access network intelligent controller (non-RT RIC) 112 of a service management orchestration (SMO) unit 110 to collect a non-real time traffic data D112 of a user, and transmit the non-real time traffic data D112 to an artificial intelligence (AI) processing unit 130. The second data collecting step S12 is performed to configure a near-real time radio access network intelligent controller (near-RT RIC) 122 of an O-RAN element unit 120 to collect a near-real time traffic data D122 of the user, and transmit the near-real time traffic data D122 to the AI processing unit 130. The classifying step S13 is performed to configure the AI processing unit 130 to classify the user into one of a plurality of categories according to the at least one of the non-real time traffic data D112 and the near-real time traffic data D122. The index predicting step S14 is performed to configure the AI processing unit 130 to calculate the one of the categories and the at least one of the non-real time traffic data D112 and the near-real time traffic data D122 by an AI model 132 to predict at least one traffic index of the user. The determining step S15 is performed to configure the AI processing unit 130 to determine whether the user is a malicious device according to the at least one traffic index of the user. Thus, the method S10 for 5G security management of the malicious device based on the O-RAN architecture of the present disclosure is different from the conventional information security protection systems, which are focusing on protecting the peripheral device, utilizes the O-RAN architecture to construct a security management method and a security management system for the mobile communicating network, and determining the malicious device via at least one of the non-real time traffic data D112 and the near-real time traffic data D122 (i.e., behavior of the control plane and the data plane) of the user device.

In the embodiment of FIG. 3, the classifying step S13 is performed to configure the AI processing unit 130 to classify the user into one of “stationary state”, “near to the base station”, “away from the base station”, “accelerating” and “slowing down”, but the present disclosure is not limited thereto. In detail, the AI processing unit 130 calculates the traffic variation, the traffic value and the signal strength of the user according to the non-real time traffic data D112 and the near-real time traffic data D122 of the user, and classifies the user into the one of the categories (i.e., “stationary state”, “near to the base station”, “away from the base station”, “accelerating” and “slowing down”). Moreover, in other embodiments of the present disclosure, the AI processing unit can perform the classifying step and the index predicting step according to the non-real time traffic data or perform the classifying step and the index predicting step according to the near-real time traffic data, but the present disclosure is not limited thereto.

The AI processing unit 130 calculates at least one of a plurality of non-real time traffic data D112 and a plurality of near-real time traffic data D122 of a plurality of users, which are collected previously, the categories of the user and the traffic index corresponded to the users by an algorithm to train a predicting model (i.e., the AI model 132). The index predicting step S14 inputs the at least one of the non-real time traffic data D112 and the near-real time traffic data D122 and the one of the categories corresponded to the user to the AI model 132, and predicts the traffic index of the aforementioned user. The aforementioned index predicting step S14 and the determining step S15 are described in more detail below.

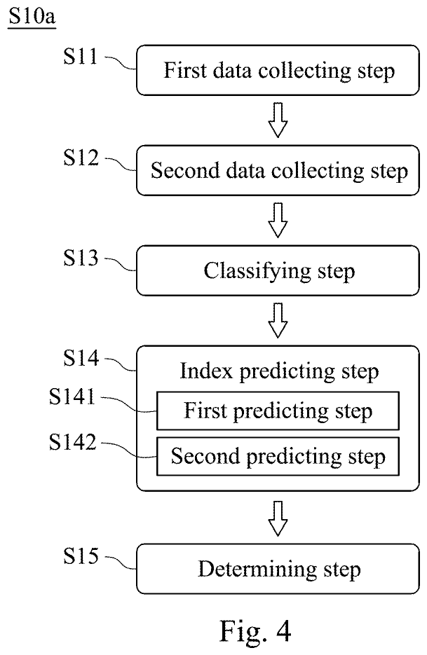

Please refer to FIGS. 1, 3 and 4. FIG. 4 shows a flow chart of a method S10a for 5G security management of a malicious device based on an O-RAN architecture according to a third embodiment of the present disclosure. The method S10a for 5G security management of the malicious device based on the O-RAN architecture includes performing a first data collecting step S11, a second data collecting step S12, a classifying step S13, an index predicting step S14 and a determining step S15. In the embodiment of FIG. 4, each of the first data collecting step S11, the second data collecting step S12 and the classifying step S13 of the method S10a for 5G security management of the malicious device based on the O-RAN architecture is the same as each of the first data collecting step S11, the second data collecting step S12 and the classifying step S13 of the method S10 for 5G security management of the malicious device based on the O-RAN architecture in FIG. 3, and will not be described again. The index predicting step S14 can include a first predicting step S141 and a second predicting step S142.

At least one traffic index includes a performance stability and a mobile stability. The first predicting step S141 is performed to configure the AI processing unit 130 to predict the performance stability of the user according to the one of the categories of the user. The second predicting step S142 is performed to configure the AI processing unit 130 to predict the mobile stability of the user according to the one of the categories of the user. The performance stability can be one of a Reference Symbol Received Power (RSRP), a Reference Signal Received Quality (RSRQ) and a Channel Quality Indicator (CQI). The mobile stability can be determined by the GPS or the 5G position information of the user.

In other embodiments of the present disclosure, the first predicting step S141 and the second predicting step S142 can be performed at the same time or the first predicting step S141 can be performed before or after the second predicting step S142, but the present disclosure is not limited thereto.

The determining step S15 can include configuring the AI processing unit 130 to compare the time stamp of the user and a standard time stamp. In response to determining that the time stamp is different from the standard time stamp, the user is determined to be the malicious device. For example, the standard time stamp is listed in Table 1. The standard time stamp represents the time when a signal is transmitted. The time jitter represents a timer interval between the previous signal transmitted time and the next signal transmitted time. In Table 1, the time jitter of the standard time stamp is stable, that is, the time intervals between each two of the signal transmitted time are the same. The time jitter is listed as Table 2 when the user is determined as the malicious device. In Table 2, the time jitter between each two of the signal transmitted time is unstable, that is, the time intervals between each two of the signal transmitted time are different.

TABLE 1

| | |
|---|---|
| standard time stamp | time jitter |

| | | |
|---|---|---|
| 1^{st} | second | 1 second |
| 2^{nd} | second | 1 second |
| 3^{rd} | second | 1 second |

TABLE 2

| | |
|---|---|
| time stamp | time jitter |

| | | | |
|---|---|---|---|
| 1^{st} | second | 1 | second |
| 2.9^{th} | second | 1.9 | second |
| 3^{rd} | second | 0.1 | second |

In other embodiments of the present disclosure, the determining step S15 can configure the AI processing unit 130 to calculate a variation amount of the at least one traffic index. In response to determining that the variation amount is different from a standard variation amount of the one of the categories, the user is determined to be the malicious device. For example, when the user is classified as “stationary state”, the standard variation amount of “stationary state” in a specific time is 0. If the variation amount of the user in the aforementioned specific time is detected as a non-zero value not 0, the user might be invaded by a malicious program, therefore, the user is determined as the malicious device.

In other embodiments of the present disclosure, the determining step S15 can configure the AI processing unit 130 to calculate a variation amount of the at least one traffic index. In response to determining that the variation amount is different from a historical variation amount of the user, the user is determined to be the malicious device. For example, the historical variation amount is a variation of the traffic index of the user in a specific time interval, which is stored by the AI processing unit 130. A historical variation amount of the aforementioned user in the specific time interval (e.g., after 22 o'clock) is 0. When the variation amount of the traffic index of the aforementioned user after 22 o'clock is detected as a non-zero value, the aforementioned user is determined as the malicious device.

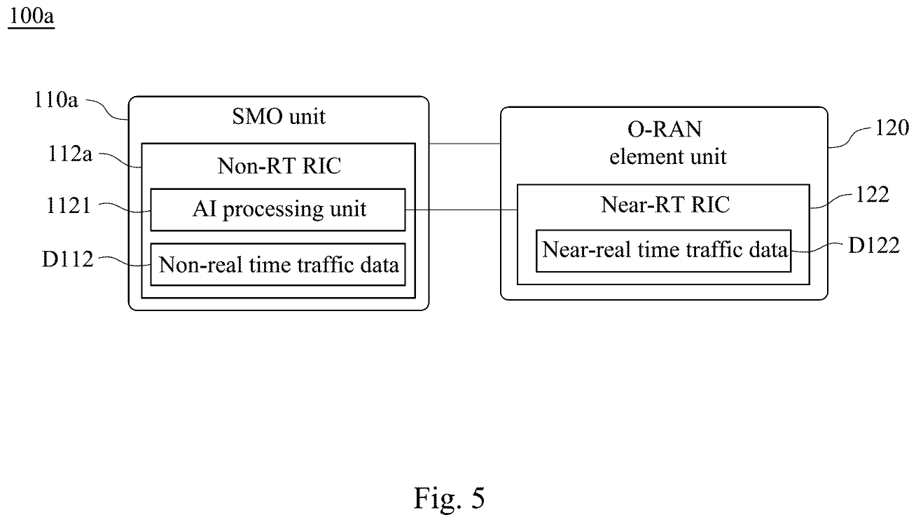

Please refer to FIGS. 1 and 5. FIG. 5 shows a block diagram of an apparatus 100a for 5G security management of a malicious device based on an O-RAN architecture according to a fourth embodiment of the present disclosure. The apparatus 100a for 5G security management of the malicious device based on the O-RAN architecture includes a SMO unit 110a and an O-RAN element unit 120. The SMO unit 110a includes a non-RT RIC 112a. The non-RT RIC 112a collects a non-real time traffic data D112 of a user, and includes at least one AI processing unit 1121. The O-RAN element unit 120 is signally connected to the SMO unit 110a, and includes a near-RT RIC 122. The near-RT RIC 122 collects a near-real time traffic data D122 of the user.

In the embodiment of FIG. 5, each of the O-RAN element unit 120, the near-RT RIC 122 and the AI processing unit 1121 of the apparatus 100a for 5G security management of the malicious device based on the O-RAN architecture is the same as each of the O-RAN element unit 120, the near-RT RIC 122 and the AI processing unit 130 of the apparatus 100 for 5G security management of the malicious device based on the O-RAN architecture in FIG. 1, and will not be described again. Further, the AI processing unit 1121 is not disposed at a remote external physical processing device. The AI processing unit 1121 can be a rAPP of the non-RT RIC 112a. Thus, the apparatus 100a for 5G security management of the malicious device based on the O-RAN architecture of the present disclosure can provide an information security management method, which is applied to 5G O-RAN architecture with less physical device, and applied to different environment.

According to the aforementioned embodiments and examples, the advantages of the present disclosure are described as follows.
1. The apparatus for 5G security management of the malicious device based on the O-RAN architecture can be set for the O-RAN architecture by the software, monitor the state of the traffic data and the information security of the protocol of the under layer communicating device (i.e., O-RAN element unit) and the protocol of the upper layer management device (i.e., SMO unit) constantly, and then train the aforementioned traffic data by the AI model to distinguish the malicious device. The aforementioned classifying step, the index predicting step and the determining step are described in more detail below.
2. The method for 5G security management of the malicious device based on the O-RAN architecture of the present disclosure is different from the conventional information security protection systems, which are focusing on protecting the peripheral device, utilize the O-RAN architecture to establish a security management method and system thereof for the mobile communicating network, and determining the malicious device via at least one of the non-real time traffic data and the near-real time traffic data (i.e., behavior of the control plane and the data plane) of the user device.
3. The apparatus for 5G security management of the malicious based on the O-RAN architecture of the present disclosure can provide an information security management method, which is applied to 5G O-RAN architecture with less physical device, and applied to different environment.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An apparatus for 5G security management of a malicious device based on an open-radio access network (O-RAN) architecture comprising:
a service management orchestration (SMO) unit comprising:
a non-real time radio access network intelligent controller (non-RT RIC) collecting a non-real time traffic data of a user;
an O-RAN element unit signally connected to the SMO unit, and comprising:
a near-real time radio access network intelligent controller (near-RT RIC) collecting a near-real time traffic data of the user; and
an artificial intelligence (AI) processing unit signally connected to the non-RT RIC and the near-RT RIC, receiving at least one of the non-real time traffic data and the near-real time traffic data, and configured to implement a method for 5G security management of the malicious device based on the O-RAN architecture comprising:
performing a classifying step to classify the user into one of a plurality of categories according to the at least one of the non-real time traffic data and the near-real time traffic data;
performing an index predicting step to calculate the one of the categories and the at least one of the non-real time traffic data and the near-real time traffic data by an AI model to predict at least one traffic index of the user; and
performing a determining step to determine whether the user is the malicious device according to the at least one traffic index of the user.

2. The apparatus for 5G security management of the malicious device based on the O-RAN architecture of claim 1, wherein,
the non-RT RIC collects the non-real time traffic data via an O1 interface; and
the near-RT RIC collects the near-real time traffic data via an E2 interface.

3. The apparatus for 5G security management of the malicious device based on the O-RAN architecture of claim 1, wherein each of the non-real time traffic data and the near-real time traffic data is at least one of a control plane, a data plane and a time stamp.

4. The apparatus for 5G security management of the malicious device based on the O-RAN architecture of claim 3, wherein the determining step comprises:
configuring the AI processing unit to compare the time stamp of the user and a standard time stamp;
wherein in response to determining that the time stamp is different from the standard time stamp, the user is determined to be the malicious device.

5. The apparatus for 5G security management of the malicious device based on the O-RAN architecture of claim 1, wherein the at least one traffic index comprises a performance stability and a mobile stability.

6. An apparatus for 5G security management of a malicious device based on an open-radio access network (O-RAN) architecture comprising:
a service management orchestration (SMO) unit comprising:
a non-real time radio access network intelligent controller (non-RT RIC) collecting a non-real time traffic data of a user, and comprising at least one artificial intelligence (AI) processing unit; and
an O-RAN element unit signally connected to the SMO unit, and comprising:
a near-real time radio access network intelligent controller (near-RT RIC) collecting a near-real time traffic data of the user;
wherein the AI processing unit is signally connected to the near-RT RIC, receiving at least one of the non-real time traffic data and the near-real time traffic data, and configured to implement a method for 5G security management of the malicious device based on the O-RAN architecture comprising:
performing a classifying step to classify the user into one of a plurality of categories according to the at least one of the non-real time traffic data and the near-real time traffic data;
performing an index predicting step to calculate the one of the categories and the at least one of the non-real time traffic data and the near-real time traffic data by an AI model to predict at least one traffic index of the user; and
performing a determining step to determine whether the user is the malicious device according to the at least one traffic index of the user.

7. The apparatus for 5G security management of the malicious device based on the O-RAN architecture of claim 6, wherein,
the non-RT RIC collects the non-real time traffic data via an O1 interface; and
the near-RT RIC collects the near-real time traffic data via an E2 interface.

8. The apparatus for 5G security management of the malicious device based on the O-RAN architecture of claim 6, wherein each of the non-real time traffic data and the near-real time traffic data is at least one of a control plane, a data plane and a time stamp.

9. The apparatus for 5G security management of the malicious device based on the O-RAN architecture of claim 8, wherein the determining step comprises:
configuring the AI processing unit to compare the time stamp of the user and a standard time stamp;
wherein in response to determining that the time stamp is different from the standard time stamp, the user is determined to be the malicious device.

10. The apparatus for 5G security management of the malicious device based on the O-RAN architecture of claim 6, wherein the at least one traffic index comprises a performance stability and a mobile stability.

11. A method for 5G security management of a malicious device based on an open-radio access network (O-RAN) architecture comprising:
performing a first data collecting step to configure a non-real time radio access network intelligent controller (non-RT RIC) of a service management orchestration (SMO) unit to collect a non-real time traffic data of a user, and transmit the non-real time traffic data to an artificial intelligence (AI) processing unit;
performing a second data collecting step to configure a near-real time radio access network intelligent controller (near-RT RIC) of an O-RAN element unit to collect a near-real time traffic data of the user, and transmit the near-real time traffic data to the AI processing unit;
performing a classifying step to configure the AI processing unit to classify the user into one of a plurality of categories according to at least one of the non-real time traffic data and the near-real time traffic data;
performing an index predicting step to configure the AI processing unit to calculate the one of the categories and the at least one of the non-real time traffic data and the near-real time traffic data by an AI model to predict at least one traffic index of the user; and
performing a determining step to configure the AI processing unit to determine whether the user is the malicious device according to the at least one traffic index of the user;
wherein the O-RAN element unit is signally connected to the SMO unit, and the AI processing unit is signally connected to the near-RT RIC.

12. The method for 5G security management of the malicious device based on the O-RAN architecture of claim 11, wherein the at least one traffic index comprises a performance stability and a mobile stability, and the index predicting step comprises:
performing a first predicting step to configure the AI processing unit to predict the performance stability of the user according to the one of the categories of the user; and
performing a second predicting step to configure the AI processing unit to predict the mobile stability of the user according to the one of the categories of the user.

13. The method for 5G security management of the malicious device based on the O-RAN architecture of claim 11, wherein each of the non-real time traffic data and the near-real time traffic data is at least one of a control plane, a data plane and a time stamp.

14. The method for 5G security management of the malicious device based on the O-RAN architecture of claim 13, wherein the determining step comprises:
configuring the AI processing unit to compare the time stamp of the user and a standard time stamp;
wherein in response to determining that the time stamp is different from the standard time stamp, the user is determined to be the malicious device.

15. The method for 5G security management of the malicious device based on the O-RAN architecture of claim 11, wherein the determining step comprises:
configuring the AI processing unit to calculate a variation amount of the at least one traffic index;
wherein in response to determining that the variation amount is different from a standard variation amount of the one of the categories, the user is determined to be the malicious device.

16. The method for 5G security management of the malicious device based on the O-RAN architecture of claim 11, wherein the determining step comprises:
configuring the AI processing unit to calculate a variation amount of the at least one traffic index;
wherein in response to determining that the variation amount is different from a historical variation amount of the user, the user is determined to be the malicious device.
